(19) United States
(12) Patent Application Publication
(10) Pub. No.: US 2009/0009958 A1
(43) Pub. Date: Jan. 8, 2009

(54) System and Method for Rack Mounted Information Handling System Supplemental Cooling

(76) Inventor: John Pflueger, Austin, TX (US)

Correspondence Address: HAMILTON & TERRILE, LLP, P.O. BOX 203518, AUSTIN, TX, 78720, US

(21) Appl. No.: 11/772,307

(22) Filed: Jul. 2, 2007

(51) Int. Cl. G06F 1/20

(52) U.S. Cl. 361/687; 361/690; 361/701

(57) ABSTRACT

Thermal management for information handling systems is provided with a bypass cooling module that allows passive airflow from an exhaust aisle to a cooling aisle in a data center. A thermal extraction device, such as a heat sink with cooling fins or a liquid filled radiator, disposed in the bypass cooling module extracts thermal energy from the passive airflow to enhance the availability of cooled air in the cooling aisle for use by the information handling systems. A thermal energy transfer device, such as a secondary heat exchanger, transfers thermal energy from the bypass module towards a data center air conditioner. The bypass module is sized to fit into standardized rack slots, such as 1 U slots.

### BACKGROUND OF THE INVENTION

1. Field of the Invention

The present invention relates in general to the field of information handling system cooling, and more particularly to a system and method for rack mounted information handling system supplemental cooling.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Often, information handling systems that perform networking server and storage functions operate from a common location, typically referred to as a data center. A common location helps network administrators to maintain the information handling systems. For example, a number of information handling systems are typically supported in racks having standardized sizes, such as 1 U racks. Blade information handling systems use common power and cooling systems within a rack to help reduce the hardware and maintenance costs associated with operation of plural systems. One difficulty that tends to arise with co-location of multiple information handling systems in a data center is that the combined heat put out by the systems tends to increase the temperature of the data center to the point where individual systems have inadequate cooling airflow to operate. A variety of data center cooling architectures have been developed to address this difficulty. One common solution is to create a plenum in the data center with a raised floor so that cooling airflow passes beneath the data center to flow upwards from the floor and across the cooling airflow intakes of the information handling systems disposed in the racks. For example, raised floor cooling systems typically have tiles that support the information handling system racks. Solid tiles prevent airflow from proceeding from the plenum to the information handling systems, while perforated tiles, such as grated tiles, placed at strategic locations allow a desired cooling airflow from the plenum to the information handling systems.

Generally, one or more Computer Air Conditioners (CRACs) placed around the perimeter of a data center room provides cooling airflow to the plenum. The CRACs cool room temperature air gathered at a location distal from the perforated or grated tiles and provides pressurized cooling airflow to the plenum. One example configuration provides approximately one perforated tile of approximately two foot by two foot to each rack in the data center. The racks are disposed in rows to form cooling aisles where the perforated tiles provide cooling airflow to information handling system cooling airflow intakes and exhaust aisles where information handling systems exhaust airflow back towards the CRACs. In a typical data center, this type of cooling architecture generally provides cooling of between 2.5 and 8.5 kilowatts per rack. However, as information handling systems have become more powerful, the power density of the information handling systems has also increased. The increased heat produced as a byproduct of information handling system operations has sometimes strained the capacity of data centers to provide sufficient cooling airflow. Thermal management of data centers will continue to present a challenge as information handling systems continue to grow more powerful.

### SUMMARY OF THE INVENTION

Therefore a need has arisen for a system and method which provides supplemental cooling for rack mounted information handling systems.

In accordance with the present invention, a system and method are provided which substantially reduce the disadvantages and problems associated with previous methods and systems for thermal management of information handling systems. A bypass module passively flows air from an exhausting aisle to a cooling aisle of information handling systems disposed in a cooled room. A thermal energy extraction device disposed in the bypass module extracts thermal energy from the passive airflow for an enhanced supply of cooling air in the cooling aisle.

More specifically, plural information handling systems are disposed in a room to have cooling airflow provided by a CRAC. The CRAC provides cooling airflow to a cooling aisle of information handling systems disposed so that their cooling airflow intakes are adjacent the cooling airflow. The CRAC accepts heated airflow from an exhausting aisle of information handling systems disposed so that their cooling airflow exhausts are adjacent the exhausting aisle. A bypass module defines a channel between the cooling and exhausting aisles so that a passive or unassisted airflow is established from the exhausting aisle to the cooling aisle through the channel by the overpressure created in the exhausting aisle relative to the cooling aisle from operation of the information handling system cooling fans. A thermal extraction device, such as a heat sink or radiator, disposed in the bypass module extracts thermal energy from the passive airflow to enhance cooling air available to the information handling systems in the cooling aisle. A thermal energy transfer device, such as a secondary heat exchanger thermally coupled with the thermal energy extraction device, transfers the extracted thermal energy to a location distal the information handling systems for return to the CRAC.

The present invention provides a number of important technical advantages. One example of an important technical advantage is that supplemental cooling airflow is provided to rack mounted information handling systems for a given data center cooling configuration. Unused rack space is leveraged to supplement cooling airflow between cooling and exhausting aisles without mechanical devices, such as additional cooling fans. Supplemental cooling units fit in standardized rack spaces for ease of configuration and maintenance, such as 1 U sized rack spaces. Secondary heat exchange interfaced with the supplemental cooling units directs excess thermal energy towards CRAC intakes to improve the efficiency with which primary cooling systems operate. Supplemental cooling units are installed without a need for electronic communications, such as signal or power interfaces, so that additional cooling is provided with minimal complexity.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a schematic diagram of plural information handling systems disposed for cooling by a CRAC, with enhanced cooling provided through bypass cooling modules;

FIG. 2 depicts a side perspective view of an information handling system rack that supports blade information handling systems and having enhanced cooling provided through bypass cooling modules inserted in standardized rack slots;

FIG. 3 depicts a cutaway view of plural bypass cooling modules having radiator thermal extraction; and

FIG. 4 depicts a cutaway view of plural bypass cooling modules having heat sink thermal extraction.

### DETAILED DESCRIPTION

Enhanced cooling for information handling systems is provided with a bypass module that cools a passive or unassisted airflow with a thermal extraction device. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

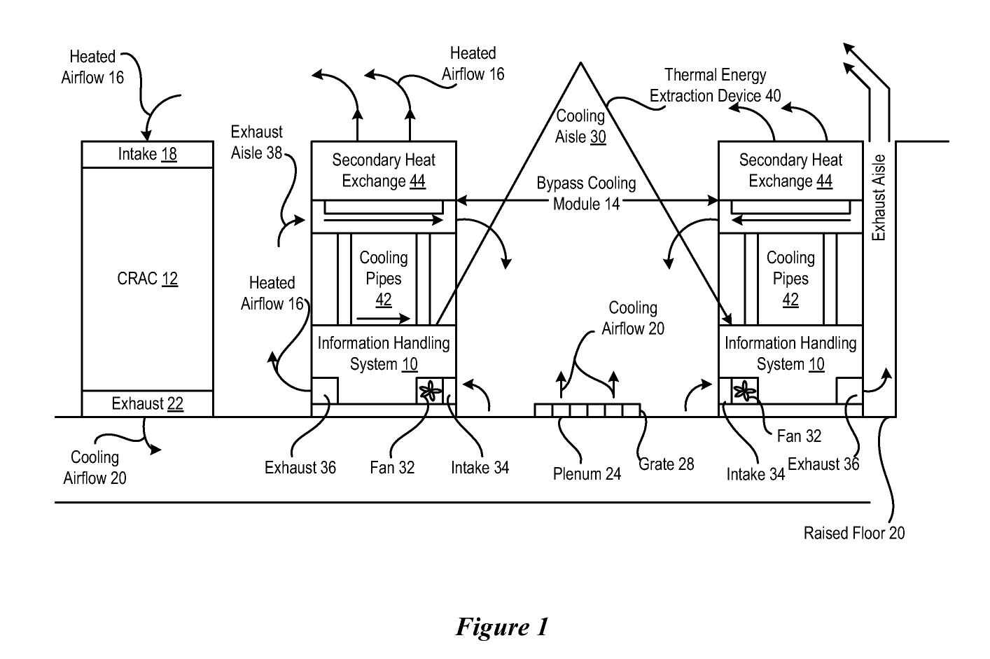

Referring now to FIG. 1, a schematic diagram depicts plural information handling systems 10 disposed for cooling by a CRAC 12, with enhanced cooling provided through bypass cooling modules 14. CRAC 12 accepts heated airflow 16 through an intake 18 and cools the air for output of a cooling airflow 20 through an exhaust 22. Cooling airflow 20 is directed to desired locations through a plenum 24 defined beneath a raised floor 26. For example, a grate 28 in raised floor 26 allows the cooling airflow to enter space proximate information handling systems 10. In the example depicted by FIG. 1, grate 28 provides cooling airflow to a cooling aisle 30 for use by information handling systems 10. Information handling system 10 includes a cooling fan 32 that draws cooling airflow 20 through an intake 34 that is adjacent to cooling aisle 30. Cooling airflow 20 passes across processing components within information handling system 10 and exits through an exhaust 26 as a heated airflow 16 to an exhausting aisle 38. In the example embodiment, cooling aisle 30 and exhausting aisle 38 are defined by the layout of information handling systems 10 so that cooling airflow 20 is exposed to intakes 34 as cooling airflow 20 proceeds upwards from grate 28. The flow rate of cooling airflow 20 is set so that a desired amount of cooling airflow reaches the uppermost information handling systems 10 without having excessive amounts of cooling airflow pass to the upper portion of cooling aisle 30. The force of heated airflow 16 as provided by fans 32 of information handling systems 10 create an overpressure in exhausting aisle 38 so that the heated airflow 16 rises upwards and into intake 18 of CRAC 12.

In order to enhance the amount of cooling airflow available for cooling of information handling systems 10, bypass cooling modules 14 form an air channel that allows heated airflow 16 to flow from exhausting aisle 38 back to cooling aisle 30. The airflow through bypass cooling module 14 is unassisted or passive, meaning that no mechanical means of forcing airflow, such as fans, are employed within bypass cooling module 14. Rather, the overpressure of heated airflow 16 relative to cooling airflow 20 caused by operation of information handling system fans 32 results in passive airflow from exhausting aisle 38 through bypass cooling module 14 to cooling aisle 30. As the passive airflow proceeds through bypass cooling module 14, it passes proximate a thermal energy extraction device 40 which extracts thermal energy to cool the passive airflow. The extracted thermal energy is transferred from thermal energy extraction device 40 with a thermal energy transfer device, such as cooling pipes 42, for exchange distal information handling systems 10. For example, cooling pipes 42 transfer the thermal energy to a secondary heat exchanger 44 which transfers the thermal energy to heated airflow 16 for cooling by CRAC 12. In effect, bypass cooling module 14 provides a passive means for recirculation of heated airflow 16 and cooling airflow 20 with intermediate thermal extraction so that information handling system fans 32 have a more substantial airflow available to provide cooling to information handling systems 10. The location and number of bypass cooling modules 14 may be varied as needed to provide desired cooling without a need for electrical or signaling interfaces to bypass cooling modules 14. In addition, airflow through a particular bypass cooling module 14 may be regulated by partially blocking the channel for passive airflow through the module, such as with a door.

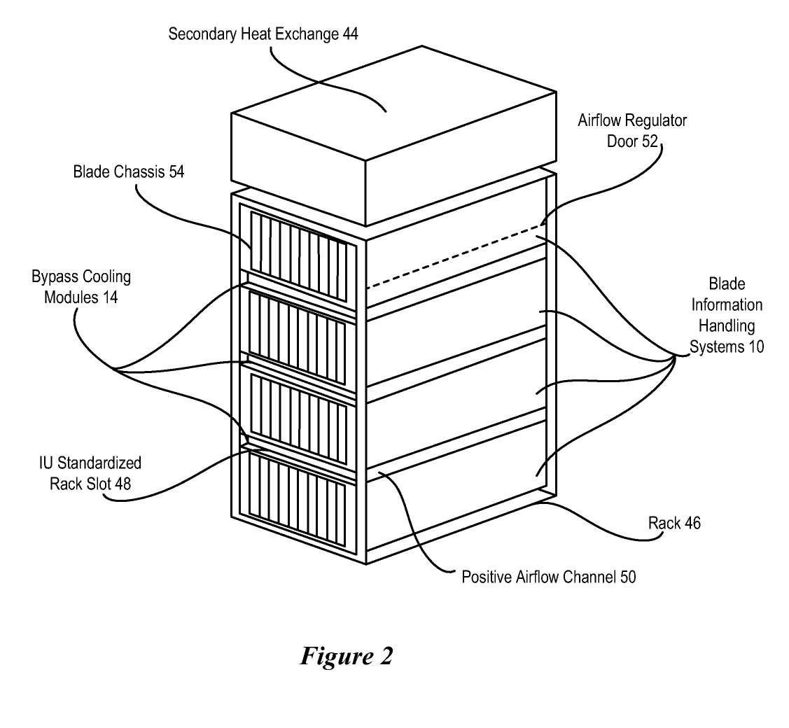

Referring now to FIG. 2, a side perspective view depicts an information handling system rack 46 that supports blade information handling systems 10 and having enhanced cooling provided through bypass cooling modules 14 inserted in standardized rack slots 48. In alternative embodiments, other types of systems might fit into standardized slots, such as 1 U slots. Racks 46 are commonly used in data center rooms to hold multiple information handling systems in minimal space by forming a plurality of standardized slots. In the example depicted by FIG. 2, blade information handling systems are inserted with a vertical orientation so that four sets of blade information handling systems are separated from each other by three 1 U standardized rack slots 48 having a horizontal orientation. A bypass cooling module 14 is inserted in each of the 1 U standardized rack slots 48 so that a passive airflow channel 50 is defined between opposing sides of rack 46 through each bypass cooling module 14. Since the airflow through each channel 50 is unassisted, that is caused by a pressure differential between the opposing sides of rack 46 rather than mechanical means within bypass cooling module 14, bypass cooling module 14 may be sized to fit in relatively small spaces, such as that provided by a 1 U slot 48. The passive airflow through each channel 50 is selectively regulated by sliding an airflow regulator door 52 into channel 50 block channel 50 a desired amount.

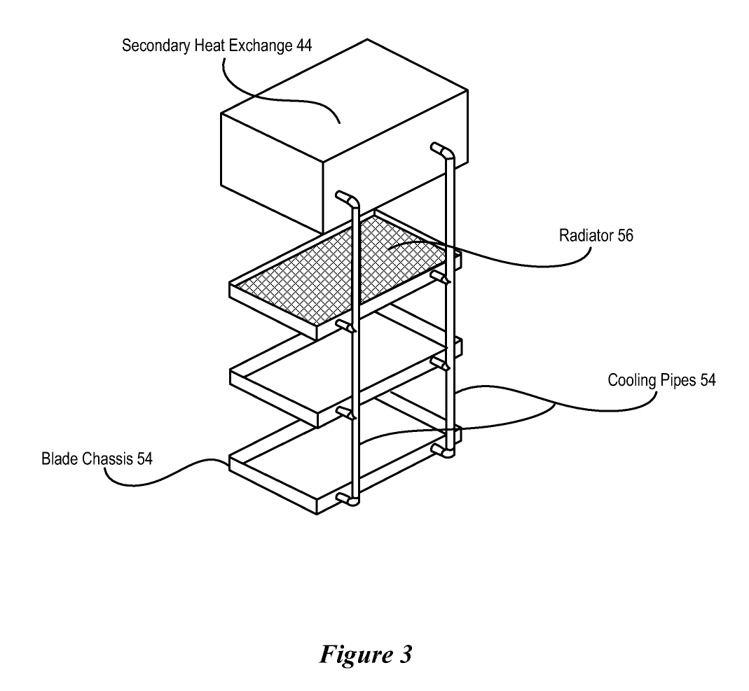

Referring now to FIG. 3, a cutaway view depicts plural bypass cooling modules 14 having radiator thermal extraction. Each bypass cooling module 14 has a chassis 54 sized to fit into a desired standardized rack slot. Within chassis 54, a radiator 56 is disposed for exposure to the passive airflow provided by a pressure differential associated with opposing sides of a rack. Radiator 56 contains a fluid which is pumped from each radiator 56 to secondary heat exchanger 44 and back to radiator 56 through cooling pipes 42. The liquid is cooled by secondary heat exchanger 44 so that heated airflow passing from an exhausting aisle across a radiator 56 is cooled before passing into a cooling aisle. In one embodiment, a radiator-based, 2-phase system is used. This system uses a fluid that vaporizes at a temperature below the hot-aisle air temperature. As the fluid moves through the radiator and picks up thermal energy, the cooling ‘fluid’ is vaporized. The vapor is then re-circulated up to the secondary heat exchanger where it is condensed back into a cooling fluid. The vaporization process helps moves the cooling material through the system similar to a pure liquid, single-phase system but without active pumping of the radiator fluid or with reduced active pumping relative to a single-phase system since, during a portion of the cooling loop, the liquid is in a vapor phase.

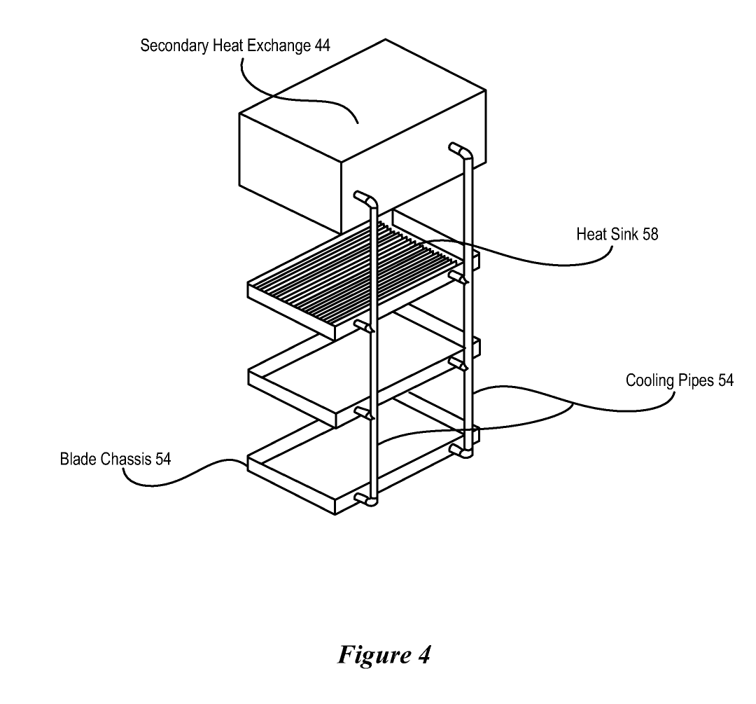

Referring now to FIG. 4, a cutaway view depicts plural bypass cooling modules 14 having heat sink thermal extraction. A heat sink 58 is provided within chassis 54 to extract thermal energy from the passive airflow. In the depicted example, heat sink 58 is formed with fins 60 that increase the surface area exposed to the passive airflow. Heat sink 58 is thermally coupled to secondary heat exchanger 44 through cooling pipes 42 which are formed from a thermally conductive material. In one embodiment, a heat sink 58 is coupled with a radiator 56 within chassis 54 to increase the surface area of thermally conductive material exposed to the cooling liquid within radiator 56. Although cooling pipes 42 are depicted as running along a single side of the rack, in one embodiment pipes that conduct thermal energy to secondary heat exchanger 44 are located in the exhausting aisle for exposure to airflow provided by information handling system fan exhaust while pipes with cooled liquid are located in the cooling aisle to limit warming by exposure to heated airflow.

Although the present invention has been described in detail, it should be understood that various changes, substitutions and alterations can be made hereto without departing from the spirit and scope of the invention as defined by the appended claims.

What is claimed is:

1. A thermal management system for managing heat generated by information handling systems, the thermal management system comprising:
plural information handling systems disposed to form one or more cooling aisles and one or more exhaust aisles, each information handling system having a cooling airflow intake exposed to the cooling aisle for accepting cooling airflow and having a cooling airflow exhaust exposed to the exhausting aisle for exhausting the cooling airflow;
an air conditioner operable to generate a cooling airflow, the air conditioner having an exhaust interfaced with the cooling aisle to provide the cooling airflow to the information handling system cooling airflow intakes and having an intake interfaced with the heating aisle to accept airflow from the information handling system cooling airflow exhausts; and
one or more bypass cooling modules disposed proximate the information handling systems, the bypass cooling module forming an air channel, the air channel providing unassisted airflow from the heating aisle to the cooling aisle.

2. The system of claim 1 further comprising a thermal exchange device disposed in the bypass cooling module air channel, the thermal exchange device operable to extract thermal energy from the unassisted airflow.

3. The system of claim 2 wherein the thermal exchange device comprises heat sinks extending through the unassisted airflow and thermally interfaced with a secondary heat exchanger.

4. The system of claim 2 wherein the thermal exchange device comprises a radiator carrying a cooling liquid.

5. The system of claim 4 further comprising a secondary heat exchanger interfaced with the radiator and operable to extract thermal energy from the liquid.

6. The system of claim 1 further comprising an airflow regulator disposed proximate the bypass cooling module air channel, the regulator operable to selectively restrict air flow through the air channel.

7. The system of claim 1 further comprising plural racks, each rack having plural slots, each slot having standardized dimensions, the rack operable to support plural information handling systems in the slots, the bypass cooling module sized to fit in a slot.

8. The system of claim 7 wherein the bypass cooling module is sized to fit in a 1 U slot.

9. The system of claim 1 wherein the plural information handling systems comprise plural blades vertically disposed in a rack and wherein the bypass cooling module is horizontally disposed adjacent to the plural blades.

10. A method for thermal management of information handling systems, the method comprising:
arranging plural information handling systems to draw cooling air from one or more cooling aisles and to exhaust cooling air to one or more exhausting aisles;
interfacing an air conditioner to exhaust cooling air into the cooling aisle and to intake heated air from the exhaust aisle;
disposing a bypass module among the information handling systems, the bypass module having an air channel between the cooling aisle and the exhausting aisle;
passively flowing cooling air from the exhaust aisle through the bypass module to the cooling aisle; and
extracting thermal energy from the cooling air as it flows through the bypass module.

11. The method of claim 10 wherein arranging plural information handling systems further comprises disposing the information handling systems in standardized slots of racks.

12. The method of claim 11 wherein disposing a bypass module further comprises disposing the bypass module in a 1 U standardized slot of a rack.

13. The method of claim 10 wherein extracting thermal energy further comprises:
flowing the cooling air across one or more heat sinks disposed in the bypass module.

14. The method of claim 10 wherein extracting thermal energy further comprises:
flowing the cooling air across a radiator disposed in the bypass module having a liquid; and
pumping the liquid to a heat exchanger for transfer of the extracted thermal energy to airflow proceeding from an exhausting aisle to the air conditioner intake.

15. The method of claim 10 wherein passively flowing further comprises:
having a pressure in the exhausting aisle proximate the bypass module of greater than a pressure in the cooling aisle proximate the bypass module without mechanical assistance from within the bypass module.

16. The method of claim 15 further comprising:
regulating air flow through the bypass module by selectively restricting the size of the air channel through the bypass module.

17. A system for thermal management of information handling systems, the system comprising:
a chassis sized to fit in an information handling system rack slot, the chassis having an air channel with a first opening aligned adjacent a cooling aisle that provides cooling airflow to the information handling systems and a second opening aligned adjacent an exhaust aisle that accepts cooling airflow exhaust from the information handling systems, the channel supporting passive airflow from the exhaust aisle to the cooling aisle;
a thermal energy extraction device disposed in the channel and operable to extract thermal energy from the passive airflow through the channel; and
a thermal energy transfer device interfaced with the thermal energy extraction device and operable to transfer the extracted thermal energy from the thermal energy extraction device to a location distal from the chassis.

18. The system of claim 17 wherein the thermal energy extraction device comprises one or more heat sinks disposed in the channel.

19. The system of claim 17 wherein the thermal energy extraction device comprises a radiator disposed in the channel, the radiator having liquid to absorb thermal energy.

20. The system of claim 17 wherein the thermal energy transfer device comprises a secondary heat exchanger disposed proximate the exhaust aisle to direct thermal energy away from the information handling systems.
